(19) United States
(12) Patent Application Publication
(10) Pub. No.: US 2005/0061786 A1
(43) Pub. Date: Mar. 24, 2005

(54) Welding method and structural body joined by using the welding method

(76) Inventors: Shigeki Saito, Kanagawa (JP); Fujiko Matsuda, Kanagawa (JP)

Correspondence Address: GREENBLUM & BERNSTEIN, P.L.C., 1950 ROLAND CLARKE PLACE, RESTON, VA, 20191, US

(21) Appl. No.: 10/488,245

(22) PCT Filed: May 19, 2003
(86) PCT No.: PCT/JP03/06235

(30) Foreign Application Priority Data
May 22, 2002 (JP) 2002-147259

(51) Int. Cl. B23K 26/20

(52) U.S. Cl. 219/121.64

(57) ABSTRACT

Provided is a welding method which can improve the joint strength while enabling simplification of the welding processing. It is a welding method for joining a plurality of members to one another by fusion welding, comprising the steps of: abutting a joint area of another member to a member having a substantially plate-type part as a joint area; and applying welding processing by using a prescribed welding device from a face of the substantially plate-type part opposite to the one onto which another member is abutted for melting the substantially plate-type part to join each member to one another.

### TECHNICAL FIELD

The present invention relates to a welding method and a structure joined by using the welding method and, more specifically, to a welding method using a welding device such as laser welding and a structure joined using the same.

### BACKGROUND ART

Most of the body frames for two-wheeled and four-wheeled vehicles are joined by welding as disclosed in Japanese Unexamined Patent Publication No. 3-186490 and Japanese Unexamined Patent Publication No. 5-77778. As such welding method, arc welding (TIG, MIG or the like) which is excellent in terms of the strength and cost is employed. An example of a case where a structure is formed using the arc welding procedure will be described by referring to FIG. 9. FIG. 9 is a cross section showing a case where a bridge pipe is placed across for joining a pair of main frames, constituting a body frame of a two-wheeled vehicle. FIG. 9 shows only the state of the joint area between the bridge pipe and one of the main frames.

As shown in FIG. 9, a center pipe element 102a as a bridge pipe 102 is connected to a unit of an outer plate 101a and an inner plate 101b as one of the main frames 101 via an end pipe element 102b. At this time, most of the part joined by arc welding is welded by fillet welding as shown by a code A in the figure and the base materials are joined to each other by filler of deposited metal.

However, the above-described arc welding is required to be performed by considering the weld line shape and welding direction (work angle) so that it is difficult to automate the welding processing. For example, only in the part denoted by the code A in FIG. 9, it is necessary to perform arc welding from the inner side (left side in FIG. 9) of the outer plate 101a. Therefore, it is difficult to automate the welding processing in the part where the outer plate 101a and the end pipe element 102b meet each other at right angles, thereby deteriorating the productivity.

Also, a large quantity of filler is used in the arc welding so that the weight of joined articles after welding increases. Thus, it is difficult to achieve weight saving. Especially, it is not an appropriate welding method for parts of two-wheeled vehicles which requires weight saving. Further, two parts to be joined by the filler are joined via a bridge. Therefore, the base materials are not directly joined to each other so that it is also inconvenient in terms of the strength.

Furthermore, when hollow molding parts are to be joined by welding, it is necessary to perform welding from the outer side of the part to be welded. This processing is difficult to be carried out so that it is difficult to fabricate the parts. For example, in the structure as shown in FIG. 9, it is obviously difficult to join the end pipe element 102b to the inner side of the outer plate 101a after the inner plate 101b and the outer plate 101a are joined or when the main frame 101 has an integral structure.

### DISCLOSURE OF THE INVENTION

An object of the present invention is to improve the shortcomings of the above-described conventional art. Especially, it is to provide a welding method which can achieve simplification of the welding processing and weight saving of structures and structures joined using the same.

In order to achieve the foregoing objects, the welding method for joining a plurality of members to one another by fusion welding according to the present invention comprises the steps of: abutting a joint area of another member against a member having a substantially plate-type part as a joint area; and applying welding processing by using a prescribed welding device from a face of the substantially plate-type part opposite to the one onto which the another member is abutted, whereby the substantially plate-type part is melted for joining each of the members to one another.

Also, in the same manner, the welding method for joining a plurality of the members to one another by fusion welding may comprise the steps of: bringing a joint area of another member close to a member having a substantially plate-type part as a joint area; and applying welding processing by using a prescribed welding device from a face of the substantially plate-type part opposite to the one to which the another member is brought close, whereby the substantially plate-type part is melted for joining each of the members to one another.

At this time, by using a welding device such as a laser welding device or an electron beam welding device, which is a generally-used welding device, welding can be easily carried out.

In this method comprising such steps, for example, when welding two prescribed members in which a member having a substantially plate-type part is welded to another member, first, one of the members is abutted or brought close to the other member. The part abutted or brought close becomes the joint area and welding processing is applied from the face of the one member on the opposite side of the joint area. Thereby, the welding area of the one member is melted and, at the same time, the other member positioned on the opposite side of the welding area is also melted thereby welding the members. Thus, the base materials are welded to each other. Therefore, welding with high bonding strength can be achieved and also welding processing can be applied from the opposite side of the welding area. As a result, welding processing can be easily applied irrespective of the positional relation between the base materials.

Further, as described, in the case where a joint area of another member is brought close to a member having a substantially plate-type part as a joint area for joining, it is desirable to form a convex part with a prescribed height on a face which is a joint area of the substantially plate-type part to which welding processing is applied by the welding device and to perform joining using the member.

Thereby, the base material itself in the convex part formed beforehand in the joint area is melted when joined, filling in the space between the base materials in the joint area. Therefore, it enables to suppress a concave part generated in the vicinity of the joint area caused when the base materials themselves are melted filling the space of the joint area, which may otherwise occur when the above-described convex part is not provided.

Also, the joint area of another member may be an end part of a protruded part formed on another member protruding towards the substantially plate-type part when being joined, and the protruded part may form a web in a joined structure by an application of welding processing.

Thereby, when fabricating a hollow member having a web (rib), welding can be performed from the opposite side of the joint area of another member in one of the members to which another member is welded but not from the side of another member to be a web. In other words, welding can be performed from the outer side of the hollow member even in the case of welding a structure which becomes a hollow member after being welded. Therefore, a hollow member can be easily and firmly fabricated by welding.

Furthermore, in a structure joined using the welding method for joining a plurality of members to one another by fusion welding, the present invention provides a structure in which a joint area of another member is abutted or brought close to a member having a substantially plate-type part as a joint area; and welding processing is applied by using a prescribed welding device from a face of the substantially plate-type part opposite to the one to which the another member is abutted or brought close, whereby the substantially plate-type part is melted for joining each of the members to one another. The structure joined in this manner exhibits high strength as described above. Therefore, the above-described objects can be achieved.

### BRIEF DESCRIPTION OF THE DRAWINGS

FIG. 1 is a schematic illustration for describing a first embodiment in which the welding method according to the present invention is applied to a main frame and, specifically, FIG. 1(a) is a block diagram mainly showing the structure of an inner plate, FIG. 1(b) is a cross section when an outer plate is mounted on the inner plate, FIG. 1(c) is an explanatory illustration showing weld lines, and FIG. 1(d) is a cross section taken along a line IV-IV;

FIG. 2 is an explanatory illustration showing the welded state of the main frame shown in FIG. 1 and, specifically, FIG. 2(a) is a cross section of the main frame, and FIG. 2(b), FIG. 2(c) are enlarged views of each welding area;

FIG. 3(a) is an explanatory illustration showing a second embodiment in which the welding method according to the present invention is applied to welding of another main frame and FIG. 3(b) is a cross section of the same;

FIG. 4(a) is an explanatory illustration showing a third embodiment in which the welding method according to the present invention is applied to welding of another main frame and FIG. 4(b) is a cross section of the same;

FIG. 5 is an explanatory illustration showing another embodiment of the welding method according to the present invention and, specifically, FIG. 5(a) is an explanatory illustration showing the position of base materials welding, FIG. 5(b) is an illustration showing the state after welding, FIG. 5(c) is an explanatory illustration showing the state where the welding areas of the base materials are improved, and FIG. 5(d) is an explanatory illustration showing still another welding method;

FIG. 6 is a schematic illustration showing a fourth embodiment in which the welding method according to the present invention is applied to connecting a head pipe and under-tank rails on the right and left and, specifically, FIG. 6(a) is an explanatory illustration showing the positional relation between the head pipe and the under-tank rails on the right and left, FIG. 6(b) is an illustration showing the joined state and FIG. 6(c) is an explanatory illustration showing the welded state of these;

FIG. 7(a) is a block diagram showing a case in which the welding method according to the present invention is applied to a body frame structure of a two-wheeled vehicle as an application target, and FIG. 7(b) is an exploded perspective view showing the body frame structure of the two-wheeled vehicle by parts;

FIG. 8 is an explanatory illustration showing a fifth embodiment in which the welding method according to the present invention is applied to a four-wheeled vehicle having a structure of mounting a prescribed parts to a body frame and, specifically, FIG. 8(a) is an illustration showing a conventional welding method and FIG. 8(b) is an illustration showing a case of using the welding method according to the present invention; and

FIG. 9 is an explanatory illustration showing a welding method of the conventional art, which is a cross section showing the connected state of a main frame and a bridge pipe.

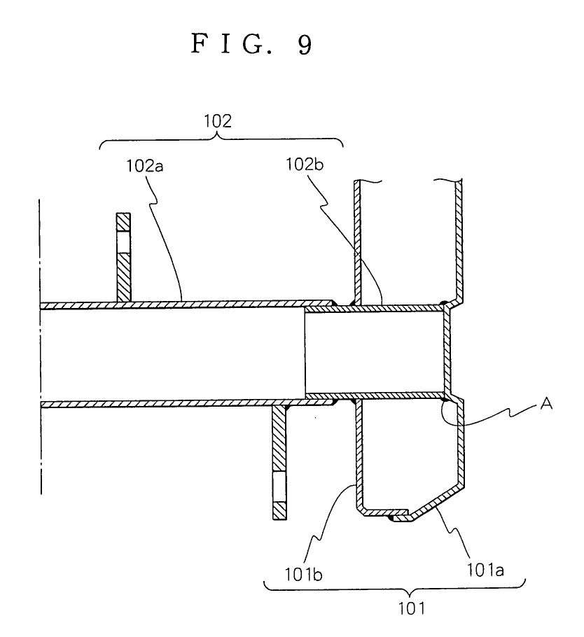

### BEST MODE FOR CARRYING OUT THE INVENTION

Embodiments of the present invention will be described hereinafter by referring to accompanying drawings.

### FIRST EMBODIMENT

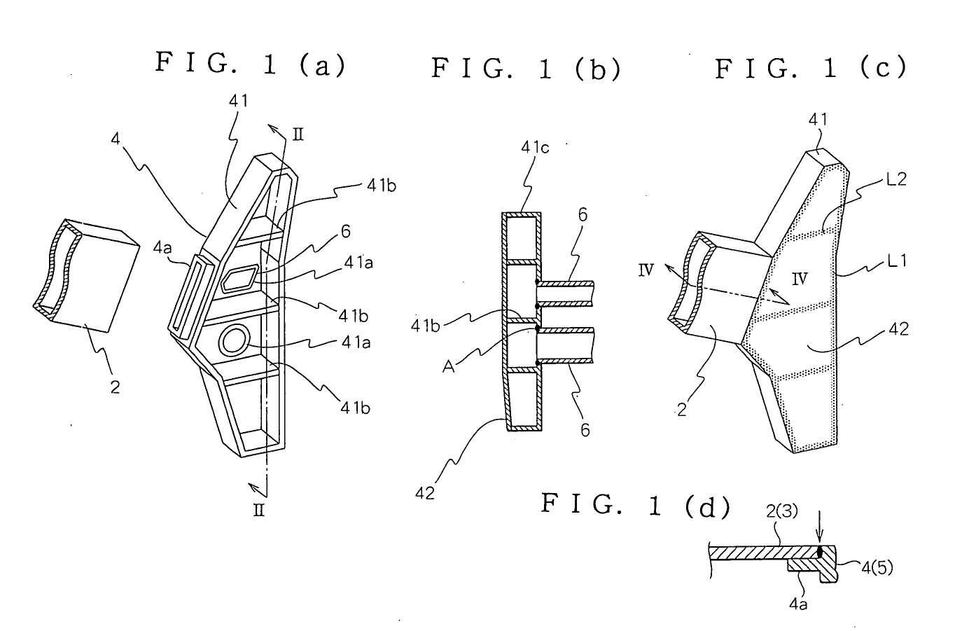

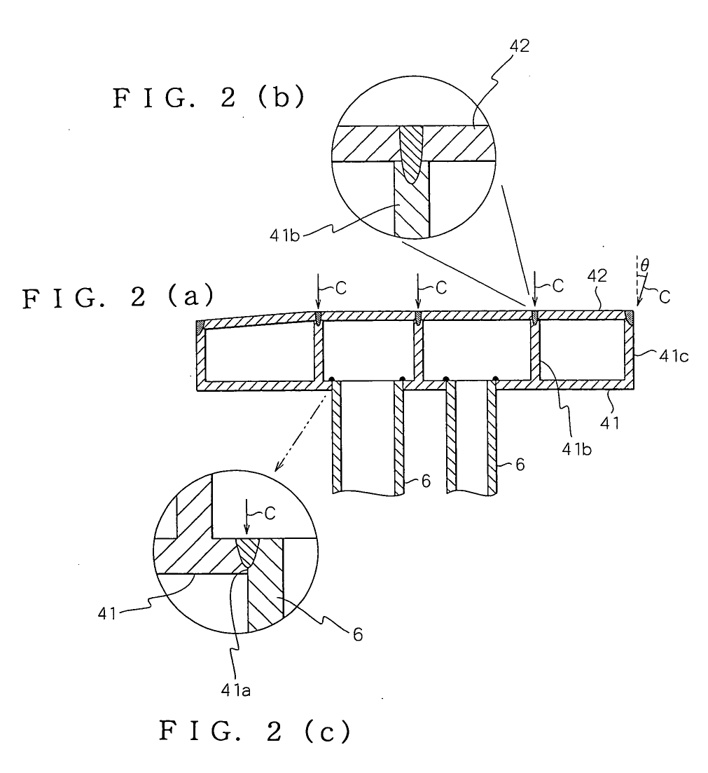

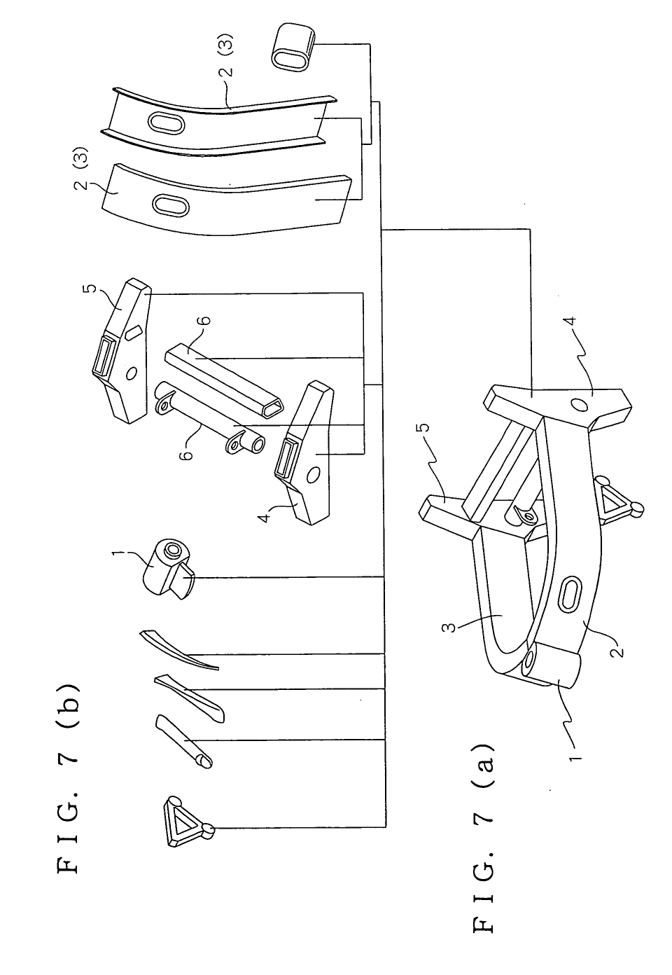

A first embodiment of the present invention will be described by referring to FIG. 1 and FIG. 2. First, a body frame of a two-wheeled vehicle for which the welding method according to the present invention is mainly used will be described by referring to FIG. 7. FIG. 7(a) shows the overall structure of the body frame of an ordinal two-wheeled vehicle and FIG. 7(b) shows members constituting the body frame of the two-wheeled vehicle shown in FIG. 7(a).

As shown in FIG. 7, the body frame of the two-wheeled vehicle comprises a head pipe 1, a pair of under-tank rails 2, 3, also a pair of main frames 4, 5 and bridge pipes 6 connected therebetween. The head pipe 1 is for supporting a steering (not shown) to be rotatable. Further, as will be described later, each of the under-tank rails 2, 3 is joined to the head pipe 1 in V-letter shape and the main frames 4, 5 are joined to each end of the under-tank rails 2, 3. The welding method according to the present invention is not limited to be used for joining the body frames of two-wheeled vehicles but may be applied to body frames of four-wheeled vehicles or other structures.

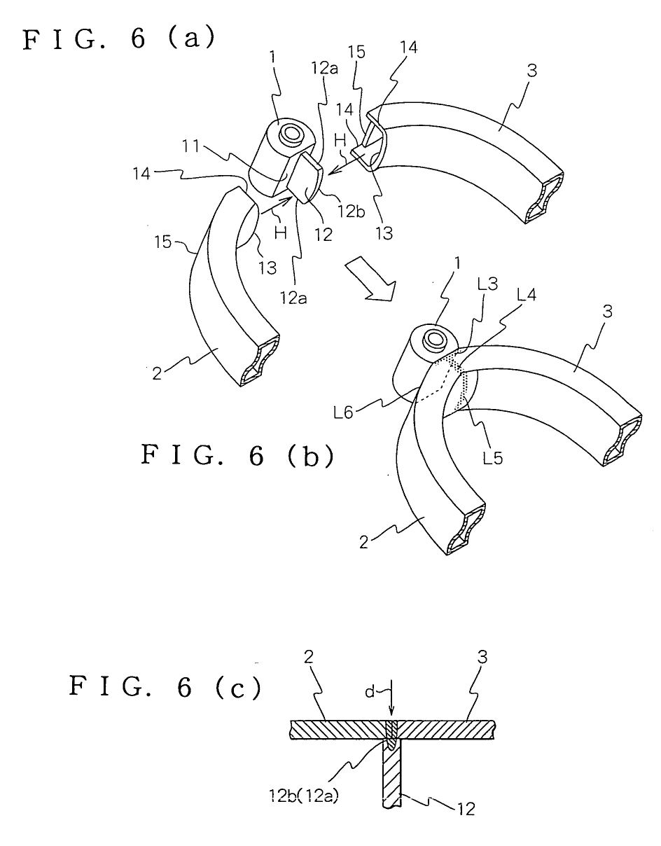

The bridge pipes 6 are connected between the main frames 4, 5 located on the right and left side. The main frames 4, 5 of the two-wheeled vehicle shown in FIG. 6 have the same structure so that description will be provided by referring to the main frame 4 on the left.

As shown in FIG. 1(a), the main frame 4 is connected to the end of the under-tank rail (left) 2 and comprises an inner plate 41 having a half-rectangular shape cross section on the whole and an outer plate 42 covering the open face of the inner plate 41.

One end of the bridge pipe 6 or the like, which connects the main frame 5 on the right side to the main frame 4 on the left side as a pair, is connected to the inner bottom face of the inner plate 41. Coupling holes (through holes) 41a to which the ends of the bridge pipe 6 are inserted are formed in the inner bottom face of the inner plate 41. One ends of the bridge pipes 6 are inserted to the coupling holes 41a of the inner plate 41. Thus, the outer face of the bridge pipe 6 fits to the inner face of the open frame of the coupling holes 41a of the inner plate 41 and the bridge pipe 6 is mounted onto the inner plate 41. The process of connecting the bridge pipes 6 to the coupling holes 41a will be described later.

Further, a plurality of protruded walls 41b protruding from the inner bottom face towards the open face are formed in the inner plate 41. As for the protruded wall 41b, the lower part fits to the inner bottom face of the inner plate 41 and the side part fits to the peripheral wall of the inner plate 41. The protruded walls 41b are formed to have substantially the same height as that of the peripheral wall 41c of the inner plate 41. Practically, however, the heights of the protruded walls 41b vary according to the shape of the outer plate 42 to be described later. That is, it is formed to have the length so as to abut onto the outer plate 42 when the outer plate 42 is mounted to the open face of the inner plate 41. It is desirable that the inner plate 41 and the protruded walls 41 bare integrated as one by casting.

The above-described outer plate 42 is for covering the open face of the inner plate 41 so that it is formed to have substantially the same external shape as that of the open face of the inner plate 41. In other words, the outer plate 42 is to cover the open face of the inner plate 41 to be substantially in flat state. However, the outer plate 42 may not be completely plane but may also be in convex shape towards the opposite side of the inner plate 41.

Next, the connecting process of the main frame 4 with the above-described structure will be described. First, one end of the bridge pipe 6 is inserted into the coupling hole 41a of the inner plate 41. At this time, the outer peripheral face of the end of the bridge pipe 6 is fitted to the open frame inner face of the coupling hole 41a of the inner plate 41 and the end of the bridge pipe 6 is positioned in substantially the same position of the inner bottom face of the inner plate 41 so as to mount the bridge pipe 6 onto the inner plate 41. In this case, the part where the inner plate 41 and the bridge pipe 6 are fitted can be observed from the open face side of the inner plate 41. Therefore, the state after the inner plate 41 and the bridge pipe 6 are put together becomes capable of welding in the fitted part of the inner plate 41 and the bridge pipe 6 from the same direction C (see FIG. 2) as the side of joining the outer plate 42 to the inner plate 41. This state is shown in FIG. 1(b) which is a cross section taken along the line II-II in FIG. 1(a). At this time, the outer plate 42 is not mounted yet.

Welding processing is applied to the fitted part A of the inner plate 41 and the bridge pipe 6 by laser welding. That is, as shown in FIG. 2(c), the fitted part of the inner plate hole 41a of the inner plate 41 and the outer peripheral face of the bridge pipe 6 are melted through fusion welding by the above-described laser welding so as to join the inner plate 41 and the bridge pipe 6 from a C direction shown in FIG. 2(c). The above-described C direction indicates the direction for observing the fitted part of the inner plate 41 and the bridge pipe 6 from the open face side of the inner plate 41.

Next, the case of joining the inner plate 41 and the outer plate 42 will be described. In this case, the inner plate 41 and the outer plate 42 are joined while keeping the posture where the inner plate 41 and the bridge pipe 6 are joined. In other words, the outer plate 42 is positioned to the open face of the inner plate 41 while keeping the posture of the inner plate 41 in which the bridge pipe 6 is joined. Then, the inner plate 41 and the outer plate 42 are put together to be in the state where the peripheral wall 41c and the protruded walls 41b of the inner plate 41 are abutted onto the inside the side face of the outer plate 42.

Further, through-welding processing is applied to the abutted part of the inner plate 41 and the outer plate 42 from the same direction as the C direction shown in FIG. 2(a) using the laser welding. That is, as shown in FIG. 2(b), the abutted part of the inner plate 41 and the outer plate 42 is melted specifically from the outer face side (the face of the side opposite to the one which the inner plate 41 abuts onto) of the outer plate 42 through fusion welding by the above-described laser welding for joining the inner plate 41 and the outer plate 42 from the C direction.

The end of the peripheral wall 41c and the end of the protruded wall 41b of the inner plate 41 abut onto the outer plate 42 (see FIG. 1(b)). The abutted part is to be the coupling part between the inner plate 41 and the outer plate 42, i.e. welding area. The welding areas are shown by thick dotted lines L1, L2 in FIG. 1(c). It can be seen that the thick dotted line L1 is continuously formed along the joint area between the outer periphery of the outer plate 42 and the peripheral wall 41c of the inner plate 41. Also, it can be seen that the thick dotted line L2 is continuously formed along the joint area between the outer plate 42 and the protruded wall 41b of the inner plate 41. At this time, the welding area is in a substantially flat plate shape with prescribed thickness. However, as described, the outer plate 42 is practically curved so that it may be in a curved plate shape.

In this case, in the above-described laser welding, laser beams are irradiated from the direction substantially perpendicular to the outer plate 42. However, as shown in FIG. 2(a), the laser beams may be irradiated from the oblique direction (for example, at an angle of 20° or less) to the outer plate 42. The method of irradiating the laser beams to the outer plate 42 from the oblique direction as described is effective in the case where the outer periphery of the outer plate is joined to the peripheral wall 41c of the inner plate 41.

Welding on the welding area shown in FIG. 1(c) is performed from the C direction shown in FIG. 2(a). That is, the welding area (substantially plate-type part) of the outer plate 42 is welded by a through-welding device in substantially vertical direction from the face on the opposite side to the one onto which the ends of the peripheral wall 41c and the protruded wall 41b of the inner plate 41 abut.

Also, welding of the inner plate 41 and the bridge pipe 6 is performed from the C direction. Therefore, welding of the inner plate 41 and the outer plate 42 and that of the inner plate 41 and the bridge pipe 6 as described can be performed from the same direction. Thus, it is a structure with the configuration suitable for automated welding and provides an ideal welding method. Laser welding was used for the through-welding device as an example, however, electron beam welding can be also used instead. A case of using laser beam device will be described hereinafter. The laser welding device and the electron beam device are widely well-known so that the detailed description will be omitted.

As described, by performing through welding from the C direction, the part of the outer plate 42 to which laser is irradiated is melted down and the melt penetrates through so that the protrude wall 41b abutting onto the opposite side is also melted down. Then, the melted state between the members becomes the part shown by a diagonal line in FIG. 2(b) and each member itself is welded to one another. In the outer peripheral part, although laser welding may be performed on the outer face of the outer plate 42 in substantially the vertical direction as described, laser beams are irradiated by slanting it at angles of θ=20° from the vertical direction as shown in FIG. 2(a). Thereby, the squared part as the outer periphery of the outer plate 42 is melted to be rounded. Also, the joint area between the inner plate 41 and the outer plate 42 positioned in the side face of the joined main frame 4 can be provided seamless.

As shown in FIG. 2(c), by irradiating laser beams to the joint area between the coupling hole 41a of the inner plate 41 and the bridge pipe 6 in substantially the vertical direction (C direction), both members in the abutted part are melted to be welded.

Thereby, the structure formed by welding becomes a hollow member and the protruded wall 41b formed substantially vertical in the inner bottom face of the inner plate 41 is joined substantially vertical to the outer plate 42 which is arranged facing the inner bottom face of the inner plate 41. Thus, the protruded wall 41b functions as a web (rib) for reinforcing the strength in the hollow structure. In other words, the protruded wall 41b becomes the web when the outer plate 42 and the inner plate 41 are taken as a flange. Further, as described, it can be joined by performing through-welding from the outside of the outer plate 42 so that the hollow member can be easily fabricated. Thus, it is unnecessary to perform arc welding which has been conventionally preformed. Therefore, it enables to easily achieve automation in accordance with the simplification of welding procedure while suppressing an increase in the weight due to the filler and deterioration in the external appearance. Furthermore, since the inner plate 41, the outer plate 42, the bridge pipe 6 as the base materials are directly welded, the bonding power can be improved while achieving a reduction in the number of welding areas and smoothing the weld line shape.

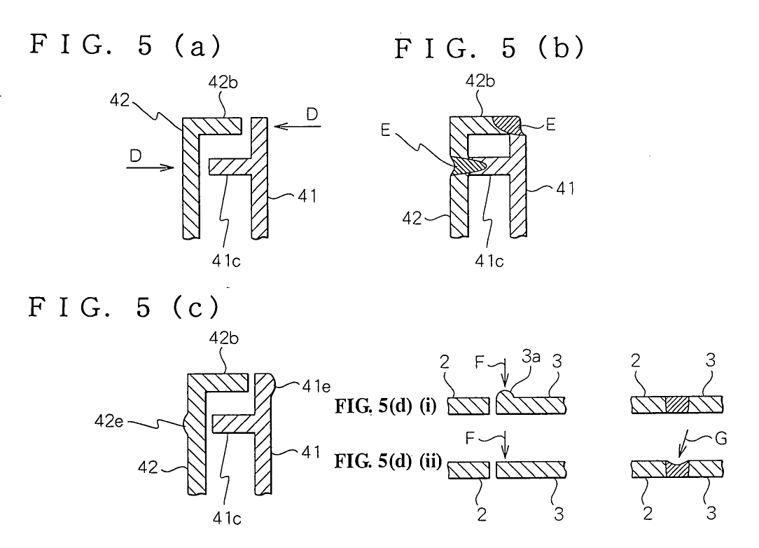

The case of abutting the inner plate 41 and the outer plate 42 by the joint area has been described above as an example, however, it is not limited to this. For example, as shown in FIG. 5(a), they can be simply brought close in the joint area, that is, in the state where they are arranged with a prescribed space in between, laser welding may be performed on the outer plate 42 side from the D direction and on the inner plate A1 side from the D direction, respectively, by changing the facing direction.

In this manner, at the joint area from D, D direction, the member to which laser beams are directly irradiated is through melted and, at the same time, the joint area of another member positioned on the opposite side to the laser irradiating side is also melted. Thus, it enables to join the outer plate 42 and the inner plate 41 as the base materials by fusing to one another. The inner plate 41 and the outer plate 42 shown in FIG. 5(a) are different from the ones shown in FIG. 1 and FIG. 2. In the figure, the peripheral wall 41c is not formed in the inner plate 41 but the peripheral wall 42b corresponding to the peripheral wall 41c is formed in the outer plate 42. Basically, the welding method is the same in such a configuration.

However, in the case as described where there is a space between the base materials before welding as shown in FIG. 5(b), a concave part (in the followings, also referred to as an under-fill) is formed on the surface of a joint piece 40, especially, on the surface (welding area) of the base material on the side to which laser beams are directly irradiated. This is because one of the base materials (the side to which laser beams are directly irradiated) itself which is melted at the time of welding shifts to fill the space between with other base materials as the welding area.

Therefore, in order to overcome the shortcoming, protruded parts 41e, 42e may be formed beforehand in the part where under-fill is likely to be generated. That is, by providing extra body in the welding area of the base material, the extra metal part is melted and fills the hollow part of the joint area. Therefore, generation of the under-fill in the welding area after being joined can be suppressed.

In FIG. 5, the case of using the inner plate 41 and the outer plate 42 as the base materials is described. However, other structural elements constituting a structure may be used as the base material instead of the inner plate 41 and the outer plate 42.

The above-described welding method can be applied to the case where the base materials are put together from right and left as shown in FIG. 5(d) and to the case where, for example, as shown in FIG. 6(c), the connecting end faces of the under-tank frame 2, 3 on the right and left are joined to the connecting end face of a protruded plate 12 of a head pipe 1. As shown in FIG. 5(d) (ii), when the laser welding is performed from the F direction in the case where there is a space in between the base materials 2, 3 on the right and left side, the under-fill is generated in a joint piece 40 as shown by an arrow G in the figure on the right side. Thus, as shown in FIG. 5(d) (i), by forming a convex part 3a beforehand in the laser-irradiating part of the under-tank frame 3, the extra metal corresponding to the convex part 3a is melted and fills the space between the base materials 2, 3. Therefore, as shown in the right figure of (i), generation of the under-fill in the joint piece 40 formed in the joint area after welding can be suppressed.

In FIG. 5, the case of using the under-tank frames 2, 3 as the base materials is described. However, other structural elements constituting a structure may be used as the base materials instead of the under-tank frames 2, 3.

Through the process as described, the main frame 4 on the left side as shown in FIG. 1 is formed with the inner plate 41 and the outer plate 42 and one end of the bridge pipe 6 is connected to the main frame 4.

The main frame 5 on the right side is composed in the same manner as that of the main frame 4 on the left side and the welding method according to the present invention is applied. The main frame 5 on the right and the bridge pipe 6 is connected by applying the welding method according to the present invention in the same manner as that of connecting the main frame 4 on the left and the bridge pipe 6.

Next, welding of the under-tank frames 2, 3 and the main frames 4, 5 will be described by referring to FIG. 1(d). FIG. 1(d) shows the welded state Of the under-tank frame 2 and the main frame 4. However, welding of the under-tank frame 3 and the main frame 5 is also performed in the same manner as shown in FIG. 1(d).

In other words, as shown in FIG. 1(a), the end part of the under-tank frame 2 is fitted to the collar part 4a of the main frame 4. Then, as shown in FIG. 1(d), welding as shown in FIG. 2(b) is performed from the arrow direction so as to connect the under-tank frame 2(3) and the main frame 4(5) using the welding method according to the present invention.

### SECOND EMBODIMENT

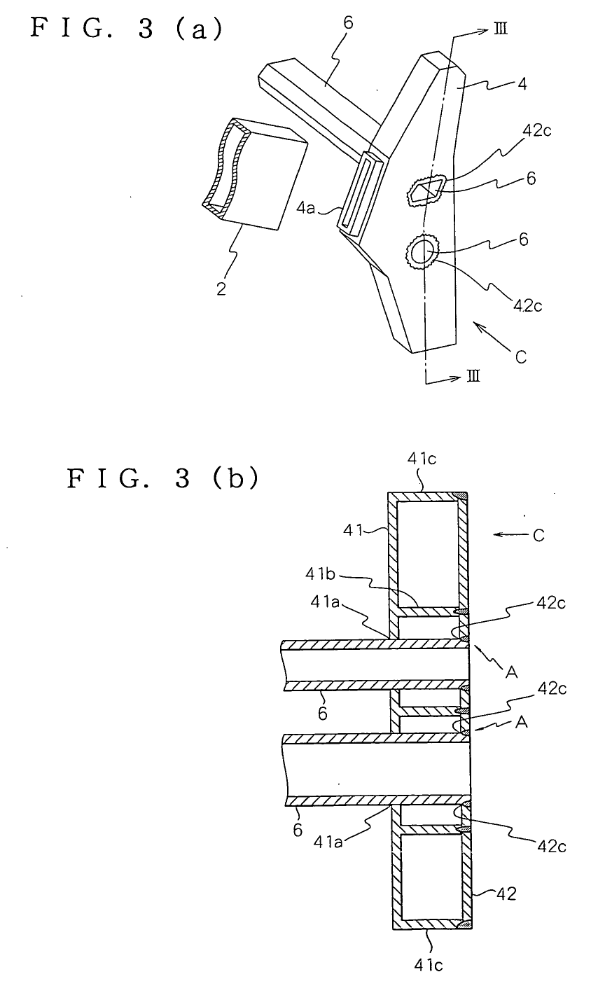

FIG. 3 shows a second embodiment in which the welding method according to the present invention is applied to the connecting structure in between the main frames 4, 5 and the bridge pipe 6. The main frames 4, 5 on the right and left have the same structure so that the main frame 4 on the left will be described as an example.

The main frame 4 on the left side shown in FIG. 3(a), (b) is the same as the main frame 4 on the left side shown in FIG. 1 in respect that it is formed by the combination of the outer plate 42 and the inner plate 41. However, it is different from the embodiment shown in FIG. 1 in respect to the connecting structure between the main frame 4 and the bridge pipe 6.

Specifically, coupling holes 42c, 41a for connecting two bridge pipes 6, 6 are formed, respectively, in the outer plate 42 and the inner plate 41 constituting the main frame 4 on the left side. Then, the outer plate 42 and the inner plate 41 constituting the main frame 4 on the left side are joined in the same manner as the embodiment shown in FIG. 1 so as to form a hollow structure.

Next, two bridge pipes 6, 6 are fitted to the inside of the coupling hole 42c of the outer plate 42 through the coupling hole 41a of the inner plate 41 which constitutes the main frame 4. Through the step, the outer peripheral face of the end part of the bridge pipe 6 is fitted to the open frame inner face of the coupling hole 42c of the outer plate 42 constituting the main frame 4 and the end part of the bridge pipe 6 is placed in the position on the same face as the outer face of the outer plate 42 constituting the main frame 4. Thereby, the bridge pipe 6 is mounted onto the outer plate 42 of the main frame 4. In this case, the part where the inner plate 41 and the bridge pipe 6 are fitted can be observed from the side where the outer plate 42 and the inner plate 41 are joined. Therefore, the state after the outer plate 42 and the bridge pipe 6 are put together becomes capable of welding in the fitted part of the outer plate 42 and the bridge pipe 6 from the same direction C as the side of joining the outer plate 42 to the inner plate 41. This state is shown in FIG. 3(b) which is a cross section taken along the line III-III in FIG. 3(a).

Welding processing is applied to the fitted part A of the outer plate 42 constituting the main frame 4 and the bridge pipe 6 by the laser welding. That is, in the same manner as the method shown in FIG. 2(c), the fitted part of the outer plate 42 constituting the main frame 4 on the left side and the bridge pipe 6, especially the fitted part of the coupling hole 42c of the outer plate 42 and the outer peripheral face of the bridge pipe 6 are melted through fusion welding by the above-described laser welding so as to join the outer plate 42 constituting the main frame 4 and the bridge pipe 6 from the C direction. The above-described C direction indicates the direction for observing the fitted part of the outer plate 42 and the bridge pipe 6 from the open face side of the inner plate 41 constituting the main frame 4. The outer plate 42 constituting the main frame 4 is joined to the inner plate 41 in the C direction.

The main frame 5 on the right side is composed in the same manner as that of the main frame 4 on the left side and the welding method according to the present invention is applied. The main frame 5 on the right side and the bridge pipe 6 are connected by applying the welding method according to the present invention in the same manner as that of connecting the main frame 4 on the left and the bridge pipe 6.

Through the above-described steps, the main frames A 5 on the right and left side are formed with the outer plate 42 and the inner plate 41 and two bride pipes 6, 6 are joined in between the main frames 4, 5 on the right and left. Also, the under-tank rails 2, 3 are fitted into the frames of the main frames 4, 5 from the outer side and joined by applying laser welding from the arrow direction.

### THIRD EMBODIMENT

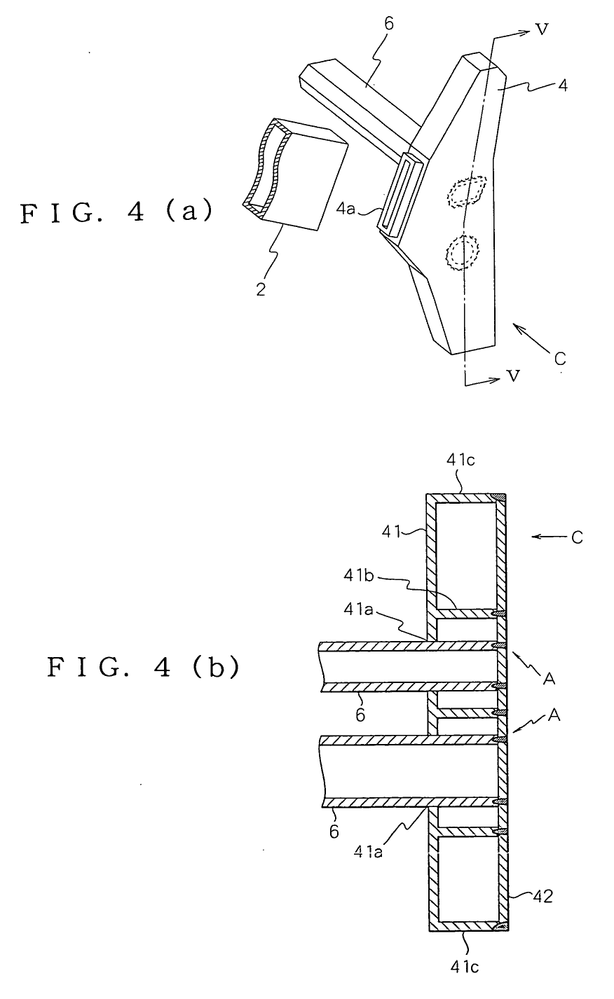

FIG. 4 is a cross section showing a third embodiment of the present invention. In the embodiment shown in FIG. 1, the inner plate 41 and the bridge pipe 6 are connected by opening the coupling hole 41a in the inner plate 41 and fitting the end part of the bridge pipe 6 into the coupling hole 41a. Also, in the embodiment shown in FIG. 3, the outer plate 42 and the bridge pipe 6 are connected by opening the coupling hole 42c in the outer plate 42 and fitting the end part of the bridge pipe 6 into the coupling hole 42c.

In the third embodiment according to the present invention as shown in FIG. 4, the bridge pipe 6 is inserted into a through hole (41a) corresponding to the coupling hole 41a of the inner plate 41; the end part of the bridge pipe 6 is abutted onto the rear side of the outer plate 42; and the outer plate 42 and the bridge pipe 6 are connected by welding using the welding method according to the present invention shown in FIG. 2(a) from the surface side of the outer plate 42. The welded state becomes similar to the state when the outer plate 42 and the protruded wall 41b of the inner plate 41 are connected by welding.

### FOURTH EMBODIMENT

Next, a fourth embodiment of the present invention will be described by referring to FIG. 6. The embodiment shown in FIG. 6 shows the case of applying the welding method according to the present invention to the method of connecting a head pipe 1 shown in FIG. 6(a) and the under-tank rails 2, 3 on the right and left.

As shown in FIG. 6(a), the head pipe 1 is formed in substantially cylindrical shape, comprising a plane part 11 formed flat in a part of the peripheral surface and a protruded plate 12 protruding from the plane part 11 in the diameter direction. A steering (not shown) is supported to be rotatable inside the cylinder. One end part each of two under-tank rails 2, 3 is to be joined to the plane part 11 and the protruded plate 12 of the head pipe 1. The protruded plate 12 is formed in the center of the plane part 11 in a flange shape with a prescribed thickness by protruding substantially vertical from the plane part 11 extending along the center axis of the head pipe 1.

Joint faces 12a, 12a on the top and bottom of the protruded plate 12, as shown in FIG. 6(a), are formed in straight shape and a joint face 12b connecting the joint faces 12a on the top and bottom is formed in curved shape so as to fit the curved shape of the inner peripheral face 13 of the joint end part of the under-tank rails 2, 3.

As shown in FIG. 6(c), the joint open frame of the under-tank rails 2, 3 is in substantially D-letter shape which is a combination of a curved part 13 on the curved inner periphery side, two straight parts 14 extending in parallel from both ends of the curved part 13, and the straight standing part 15 on the outer periphery side connecting the two straight parts 14. The inside structure of the under-tank rails 2, 3 is hollow.

When forming a structure by welding and mutually joining the protruded plate 12 of the head pipe 1 made of a metallic material and the under-tank rails 2, 3, as shown in FIG. 6(b), (c), the bonding faces (curved part 13, straight part 14) of the under-tank rail 2 and the under-tank rail 3 are put together in the thickness direction of the protruded plate 12 of the head pipe 1. Then, the joint faces 12a and 12b formed in the protruded plate 12 of the head pipe 1 are abutted onto the abutting part of the joint face (straight part 14, curved part 13) of the under-tank rails 2, 3 so as to compose the head pipe 1 and the under-tank rails 2, 3.

The joint end part of the straight part 14 and the curved part 13 of the under-tank rails 2, 3 being put together as described is in straight-line form as can be seen from the figure. Thus, the weld line for welding is formed as a straight line, thereby simplifying the shape of the weld track for moving the beams of welding.

Then, the under-tank rails 2, 3 and the head pipe 1 are fused to join one another by welding. Laser welding or electron beam welding is used for the welding as in the case of welding the main frame. The welding is continuously performed along the abutting part of the joint end face of the under-tank rails 2, 3 onto which the contact faces 12a on the top and bottom and the curved part 12b of the protruded plate 12 of the head pipe 1 are abutted.

From the different point of view, first, the under-tank rails 2, 3 on the right and left are moved as shown by an arrow H in FIG. 6(a) so that the end parts are to be abutted facing each other on the protruded plate 12. In other words, the protruded plate 12 is to be positioned inside the abutted part of the under-tank rails 2, 3, on the right and left. At this time, naturally, the plane part 11 of the head pipe 1 and the under-tank rails 2, 3 are also abutted.

Then, the laser welding is performed onto the abutted part of the under-tank rails 2, 3 on the right and left. That is, the parts where the under-tank rails 2, 3 are abutted and where the under-tank rails 2, 3 and the plane part 11 of the head pipe 1 are abutted become weld lines L3, L4, L5, L6 and the laser welding processing is applied onto the lines. The weld lines L3, L4, L5, L6, which are the parts for applying the laser processing, are shown by thick dotted lines in FIG. 6(b). The weld line on the bottom as a pair of the welding line L3, the weld line on the right side as a pair of the weld line L6, the weld line on the bottom as a pair of the weld line L4 are not shown in the figure for convenience' sake.

The fused state of the under tank rails 2, 3 and the protruded plate 12 by the laser welding is shown in FIG. 6(c). The figure is a fragmentary enlarged cross section of FIG. 6(b). As shown in the figure, when laser beams are irradiated from the C direction, the outer wall of the under-tank rails 2, 3 are melted and then the protruded plate 12 positioned on the opposite side to the laser-irradiating side of the outer wall is also melted. At this time, the end faces of the under-tank rails 2, 3 on the right and left which are in contact neighboring to one another are also melted. As a result, three parts which are in contact on the weld line are welded.

Thereby, three parts can be joined by one-time welding processing. Further, all the weld lines L3, L4, L5, L6 are in straight shape so that the weld track for laser welding is simplified. Thus, it is ideal for automating the welding. Moreover, unlike arc welding, filler is not to be attached so that the weight of the frame structure can be lightened.

### FIFTH EMBODIMENT

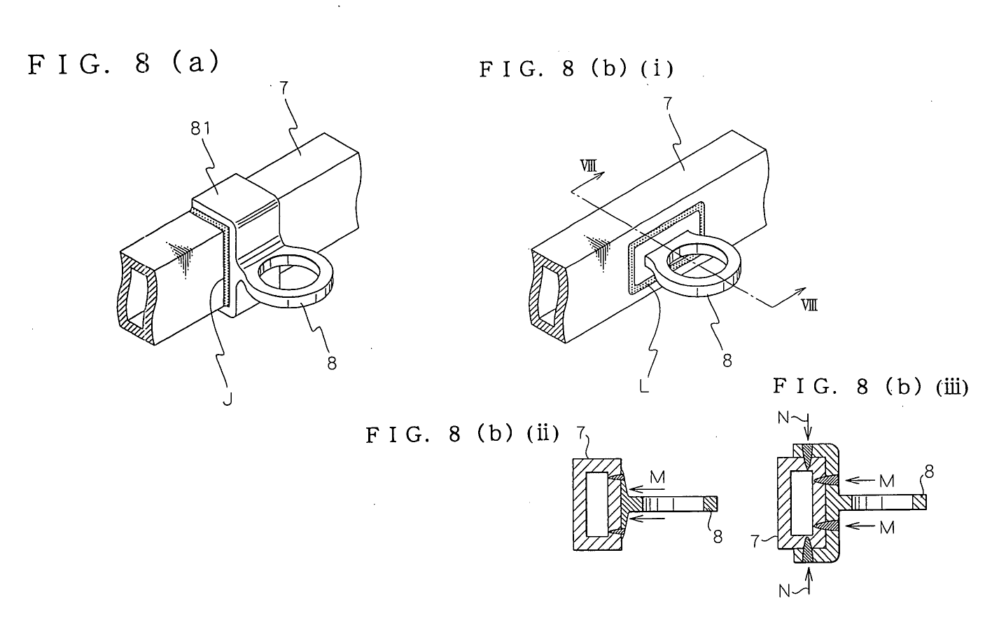

Next, a fifth embodiment of the present invention will be described by referring to FIG. 8. FIG. 8 is an explanatory illustration showing a welding method for the case of mounting a prescribed part to a body frame of a four-wheeled vehicle. FIG. 8(a) is a welding method of the conventional art and FIG. 8(b) is a case of using the welding method of the present invention. Specifically, shown is a case of welding a suspension mounting part 8 to a prescribed frame 7.

As shown in FIG. 8(a), in the conventional art, a welding part 81 of the suspension mounting part 8 is formed to surround (specifically, to surround about the half of) the bar-shape frame 7. In other words, a weld line 81 is formed along the part where the corner of the suspension mounting part 8 abuts onto the plane of the frame 7.

Therefore, when the cross section of the frame 7 is substantially square, the welding part 81 of the suspension mounting part 8 is formed in a half-rectangular shape surrounding about the half of the frame 7 or it is formed in substantially square ring shape so as to surround about the full-round. As denoted by code J, since welding processing such as arc welding is applied to the abutted part between the frame 7 and the welding part 81, the filler used in arc welding is attached. Therefore, the weight is increased.

On the contrary, when the welding method of the present invention as described is used, as shown in FIG. 8(b), the welding part 81 of the suspension mounting part 8 may be in the shape to be in contact with a part of the frame 7. For example, it may be in a plane shape as shown in (ii) or may be in a half-rectangular shape which does not even reach the half-way of the outer periphery of a frame 5 as shown in (iii). FIG. 8(b) (ii) shows the cross section taken along the line VIII-VIII in FIG. 8(b)(i).

As shown in FIG. 8(b), by performing laser welding onto the weld line denoted by the code L from the M direction shown in FIG. 8(b) (ii), along with the suspension mounting part 8, the frame 7 thereunder is also melted. Thereby, the suspension mounting part 8 and the frame 7 are joined. Also, by performing laser welding from the M direction and the N direction shown in FIG. 8(b) (iii), along with the suspension mounting part 8, the frame 7 thereunder is also melted. Thereby, the suspension mounting part 8 and the frame 7 are joined.

In this embodiment, the suspension mounting part 8 and the frame 7 are also joined by laser welding. Therefore, unlike the arc welding, filler is not attached so that it enables to avoid an increase in the weight of the structure and, at the same time, strong bonding can be achieved. Further, the laser welding can be performed by specifying the direction of the laser welding in one direction towards the surface of the suspension mounting part 8 so that automation of the welding can be easily achieved. Furthermore, the shape of the suspension mounting part 8 can be simplified to be a flat plate shape and firm bonding can be also achieved. Therefore, the weight of the suspension mounting part can be suppressed to a necessary and minimum weight. As a result, the weight of the structure can be lightened.

Furthermore, with the present invention, even though the suspension mounting part 8 in the conventional shape shown in FIG. 8(a) is used, the weight can be reduced through joining the suspension mounting part 8 and the frame 7 by using the laser welding by the amount of the filler which may otherwise be attached when using the arc welding. Considering that the filler of the arc welding has a great influence on the weight of the structure, it is evident that reduction of the weight can be achieved by providing the structure as shown in FIG. 8(b) (iii).

Industrial Applicability

The present invention is structured and functions as described. With this, the welding areas of the welding members are abutted or brought close to one another and the points are welded. The base materials are melted and welded to each other so that welding with a high bonding strength can be achieved. Further, welding processing can be applied from the opposite side of the part where the base materials are welded to each other. Therefore, unlike the conventional art, it can achieve an excellent effect which is to be able to easily apply welding processing irrespective of shapes of the base materials and the positional relations between the base materials.

Also, it enables to achieve firm welding so that the weld line shape can be simplified and reduce the number of the welding areas. At the same time, the base materials themselves are melted so that it suppresses the weld lines to be in an angular shape. Thus, the weld line shape after joining becomes smooth, thereby suppressing deterioration in the appearance of the structure after being joined.

Further, by forming a convex part having a prescribed height in the face of the joint area of the member which has a substantially plate-type part to be the joint area where welding processing is applied by a welding device, the base materials in the convex part is melted at the time of joining and fills the space in between the base materials in the joint area. Therefore, it enables to suppress a concave part generated in the vicinity of the joint area caused when the base materials themselves are melted filling the joint area, which may otherwise occur when the above-described convex part is not provided.

Furthermore, when the joint area of another member is provided to be a protruded part protruding towards the substantially plate-type part at the time of joining, the protruded part is to form a web (rib) in the joined structure by application of the welding processing. That is, in the case of fabricating a hollow member having a web (rib), welding is not performed from another member side to be a web but it can be performed from the opposite side of the joint area of the other member where the another member is to be welded. Therefore, when the member becomes a hollow member after welding, welding can be performed onto the hollow member from the outer side so that a strong hollow member can be easily fabricated by welding.

1. Canceled.

2. A welding method for joining a plurality of members to one another by fusion welding, comprising the steps of:
forming a convex part with a prescribed height on a face of a joint area of a member having a substantially plate-type part to which welding processing is applied by the welding device;
forming a protruded part in a joint area of another member to be welded to the member, which protrudes towards the substantially plate-type joint area and forms a web in a joined structure by an application of welding processing; and
bringing the convex part and the protruded part close and applying welding processing by using a laser welding device from a face of the substantially plate-type part opposite to the one to which the another member is brought close, whereby the substantially plate-type part is melted to join each of the members to one another.

3. Canceled.

4. Canceled.

5. Canceled.

6. A welding method for joining a plurality of members to one another by fusion welding, comprising the steps of:
forming a convex part with a prescribed height on a face of a joint area of a member having a substantially plate-type part to which welding processing is applied by the welding device;
forming a protruded part in a joint area of another member to be welded to the member, which protrudes towards the substantially plate-type joint area and forms a web in a joined structure by an application of welding processing; and
bringing the convex part and the protruded part close and applying welding processing by using an electron beam welding device from a face of the substantially plate-type part opposite to the one to which the another member is brought close, whereby the substantially plate-type part is melted to join each of the members to one another.

7. A structure joined by using a welding method for joining a plurality of members to one another by fusion welding, wherein: a joint area of another member is abutted onto a member having a substantially plate-type part as a joint area; and welding processing is applied by using a prescribed through-welding device from a face of the substantially plate-type part opposite to the one onto which the another member is abutted, whereby the substantially plate-type part is melted for joining each of the members to one another.

8. A structure joined by using a welding method for joining a plurality of members to one another by fusion welding, wherein: a joint area of another member is brought close to a member having a substantially plate-type part as a joint area; and welding processing is applied by using a prescribed through-welding device from a face of the substantially plate-type part opposite to the one to which the another member is brought close, whereby the substantially plate-type part is melted for joining each of the members to one another.

9. The welding method according to claim 8, wherein the joint area of the another member is an end part of a protruded part formed on the another member protruding towards the substantially plate-type part when being joined, and the protruded part forms a web in a joined structure by an application of the welding processing.
